(19) United States
(12) Patent Application Publication
(10) Pub. No.: US 2008/0239483 A1
(43) Pub. Date: Oct. 2, 2008

(54) STEREOSCOPIC DISPLAYING APPARATUS

(75) Inventors: MIKIO KURODA, NIIGATA (JP); TATSUYA SATO, NIIGATA (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ARISAWA MFG. CO., LTD., NIIGATA (JP)

(21) Appl. No.: 11/693,725

(22) Filed: Mar. 30, 2007

(51) Int. Cl. G02B 27/26

(52) U.S. Cl. 359/465

(57) ABSTRACT

A stereoscopic displaying apparatus includes: an image generating section having a right eye image generating region on which a right eye image light is generated and a left eye image generating region on which a left eye image light is generated; a polarizing plate that emits the right eye image light and the left eye image light generated by the image generating section in the same polarizing direction; and a polarization axis control plate on which the right eye image light and the left eye image light from the polarizing plate are incident, and from which the right eye image light and the left eye image light are emitted as linear polarized lights of which polarization axes are orthogonalized to each other or circularly polarized lights of which polarization axes are rotated in the directions opposite to each other. The polarization axis control plate includes: a right eye polarizing region on which a right eye image light is incident; a left eye polarizing region which is arranged adjacent to the right eye polarizing region and on which a left eye image light is incident; a plurality of light blocking sections arranged on a plane facing the polarizing plate, each of which is a boundary between the right eye polarizing region, and the left eye polarizing region that blocks the right eye image light and the left eye image light; and a plurality of apertures formed between each of the plurality of light blocking sections that transmit therethrough the right eye image light and the left eye image light. The image light emitted from one of the right eye polarizing region and the left eye polarizing region and incident on one of the plurality of apertures goes to the inside of the angle of field while the image light emitted from the other of the right eye polarizing region and the left eye polarizing region adjacent to each other and incident on the one aperture goes to the outside of the angle of field.

### BACKGROUND

1. Technical Field

The present invention relates to a stereoscopic displaying apparatus. Particularly, the present invention relates to a stereoscopic displaying apparatus that reduces cross talk of right and left image lights.

2. Related Art

A stereoscopic displaying apparatus that enables a viewer to view a stereoscopic image by generating a right eye image and a left eye image by utilizing a parallax of a right eye and a left eye of the viewer, as disclosed, for example, in Japanese Patent Application Publication No. 10-253824. The stereoscopic displaying apparatus includes a LCD panel that generates a right eye image and a left eye image, and quarter wave retarders which are arranged in the LCD panel on the viewer side, and face regions in which a right eye image and a left image are generated with phase advance axes having the angle of 90 degrees therebetween.

Viewing with an angle of field from a position at the center of the vertical, direction of the stereoscopic displaying apparatus, cross talk may occur such that a part of the right eye image generated by a liquid-crystal display panel is transmitted to the left eye of the viewer through a quarter wave retarder for the left eye.

### SUMMARY

Accordingly, it is an advantage of the invention to provide a stereoscopic displaying apparatus which is capable of solving the above-mentioned problem. This advantage may be achieved through the combination of features described, in independent claims of the invention Dependent claims thereof specify preferable embodiments of the invention.

Thus, a first aspect of the present invention provides a stereoscopic displaying apparatus including: an image generating section having a right eye image generating region on which a right eye image light is generated and a left eye image generating region on which a left eye image light is generated; a polarizing plate that emits the right eye image light and the left eye image light generated by the image generating section in the same polarizing direction; and a polarization axis control plate on which the right eye image light and the left eye image light from the polarizing plate are incident, and from which the right eye image tight and the left eye image light are emitted as linear polarized lights of which polarization axes are orthogonalized to each other or circularly polarized lights of which polarization axes are rotated in the ejections opposite to each other. The polarization axis control plate includes: a right eye polarizing region on which a right eye image light is incident; a left eye polarizing region which is arranged adjacent to the right eye polarizing region and on which a left eye image light is incident; a plurality of light blocking sections arranged on a plane facing the polarizing plate, each of which is a boundary between the right eye polarizing region and the left eye polarizing region that blocks the right eye image light and the left eye image light; and a plurality of apertures formed between each of the plurality of light blocking sections that transmit therethrough the right eye image light and the left eye image light. The image light emitted from one of the right eye polarizing region and the left eye polarizing region and incident on one of the plurality of apertures goes to the inside of the angle of field while the image light emitted from the other of the right eye polarizing region and the left eye polarizing region adjacent to each other and incident on the one aperture goes to the outside of the angle of field.

Here, all necessary features of the present invention are not listed in the summary of the invention. The sub-combinations of the features may become the invention.

### BRIEF DESCRIPTION OF THE DRAWINGS

FIG. 1 is an exploded perspective view showing a stereoscopic displaying apparatus 100 being a part of a stereoscopic image displaying system 10 according to an embodiment;

FIG. 2 is a schematic top view showing a usage state of the stereoscopic image displaying system 10;

FIG. 3 is a side view explaining in detail, an image generating section 160, a polarizing plate 170 and a polarization axis control panel 180 in the stereoscopic displaying apparatus 100;

FIG. 4 is a partially enlarged view of FIG. 3 to explain light blocking sections 190;

FIG. 5 shows a measuring result of cross talk rate C (θ); and

FIG. 6 is an exploded perspective view showing a stereoscopic displaying apparatus 101.

### DESCRIPTION OF EXEMPLARY EMBODIMENTS

Hereinafter, the present invention will now be described through preferred embodiments. The embodiments do not limit the invention according to claims and all combinations of the features described in the embodiments are not necessarily essential to means for solving the problems of the invention.

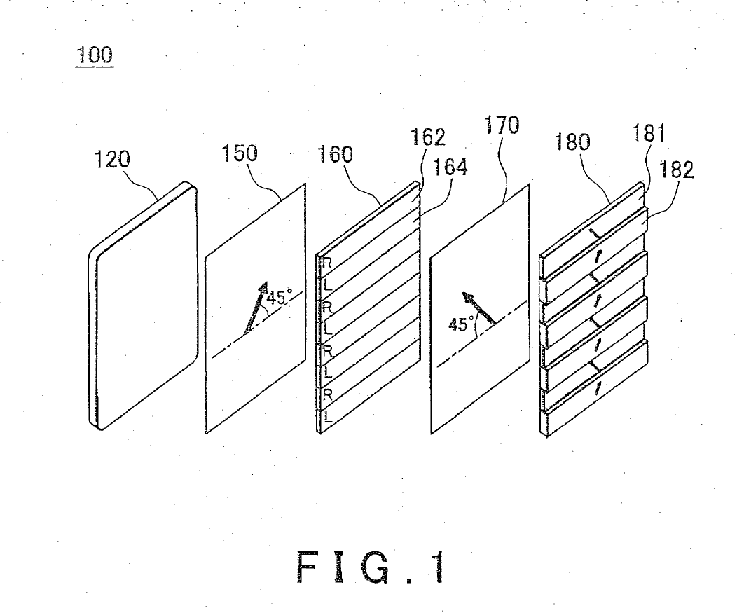

FIG. 1 is an exploded perspective view showing a stereoscopic displaying apparatus 100 being a part of a stereoscopic image displaying system 10 according to the present embodiment. The stereoscopic image displaying system 10 according to the present embodiment includes the stereoscopic displaying apparatus 100 and a polarized eye glasses 200. As shown in FIG. 1, the stereoscopic displaying apparatus 100 includes a light source 120, a polarizing plate 150, an image generating section 160, a polarizing plate 170 and a polarization axis control plate 180 in the described order, and those are accommodated in a housing (not shown in the figure). A viewer 500 views a stereoscopic image displayed on the stereoscopic displaying apparatus 100 from the right side of the polarization axis control plate 180 shown in FIG. 1.

The light source 120 is arranged on the innermost of the stereoscopic displaying apparatus 100 from the viewpoint of the viewer 500 and emits a white non-polarized light to one surface of the polarizing plate 150 in using the stereoscopic displaying apparatus 100. Here, the light source 120 is a surface illuminant in the present embodiment, however, the light source 120 may be a combination of such as a point light source and a condenser lens instead of the surface illuminant. An example of condenser lens is a Fresnel lens.

The polarizing plate 150 is provided on the image generating section 160 at the light source 120 side. The polarizing plate 150 has a transmission axis and a absorption axis orthogonalized to the transmission axis, and when non-polarized light emitted from the light source 120 is incident thereon, transmits light having the polarization axis in parallel with the transmission axis direction among the non-polarized light but blocks light having the polarization axis in parallel with the absorption axis direction.

Here, the polarization axis direction is a direction to which light oscillates in the electric field. The transmission axis direction of the polarizing plate 150 is the direction toward the upper right having the angle of 45 degrees with the horizontal direction when the viewer 500 views the stereoscopic displaying apparatus 100 shown as an arrow in FIG. 1.

The image generating section 160 has right eye image generating regions 162 and left eye image generating regions 164.

Each of the right eye image generating regions 162 and the left eye image generating regions 164 are obtained by dividing the image generating section 160 by the horizontal direction, and a plurality of right eye image generating regions 162 and left eye image generating regions 164 are alternately arranged in the vertical direction as shown in FIG. 1. In using the stereoscopic displaying apparatus 100, a right eye image is generated in each right eye image generating region 162 and a left eye image is generated in each left eye image generating region 164 in the image generating section 160, respectively.

At this time, light transmitted through, the polarizing plate 150 is incident on the right eye image generating region 162 and the left eye image generating region 164 in the image generating section 160, and then, the light transmitted through the right eye image generating region 162 becomes an image light of the right eye image (hereinafter referred to as a right eye image light) and the light transmitted through the left eye image generating region 164 becomes an image light of the left eye image (hereinafter referred to as a left eye image light). Here, each of the right eye image light transmitted through the right eye image generating region 162 and the left eye image light transmitted through the left eye image generating region 164 are linear polarized light having the polarization axis in a specified direction. Here, each of the polarization axis in the specified direction may be in the same direction each other. For example, each polarization axis is in the direction the same as that of the transmission axis of the polarizing plate 170 described later as shown in FIG. 1. In such image generating section 160, a plurality of small cells are arranged in a matrix in a plane in the horizontal direction and the vertical direction, for example, and a LCD (liquid crystal display) in which liquid crystal is sealed in each cell sandwiched between oriented films is used. Each cell is electrically driven in the LCD, so that each cell switches between a state that the light is transmitted therethrough without changing the direction of the polarization axis and a state that the light is transmitted therethrough with rotating the direction of the polarization axis by 90 degrees. The right eye image generating region 162 and the left eye image generating region 164 may be alternately arranged per cell, or alternately arranged for each of the predetermined number of cells in the vertical direction.

The polarizing plate 170 is provided in the image generating section 160 on the viewer 500 side. When the right eye image light transmitted through the right eye image generating region 162 and the left eye image light transmitted through the left eye image generating region 164 are incident thereon, the polarizing plate 170 transmits the light of which, polarization axis is in parallel with the transmission axis but blocks the light of which polarization axis is in parallel with the absorption axis among the incident lights. Here, the direction of the transmission axis of the polarizing plate 170 is 45 degrees upper left direction from the horizontal direction when the viewer 500 views the stereoscopic image display section 100 shown as the arrow in FIG. 1.

The polarization axis control plate 180 includes first polarizing regions 181 and second polarizing regions 182. The size and the position for each of the right eye polarizing regions 181 and each of the left eye polarizing regions 182 in the polarization axis control plate 180 are arranged such that the right eye image light transmitted through the right eye image generating region 162 is incident on the right eye polarizing region 181 and the left eye image light transmitted through the left eye image generating region 164 is incident on the left eye polarizing region 182 when the stereoscopic displaying apparatus 100 is viewed horn the central position of the front by a predetermined viewing distance.

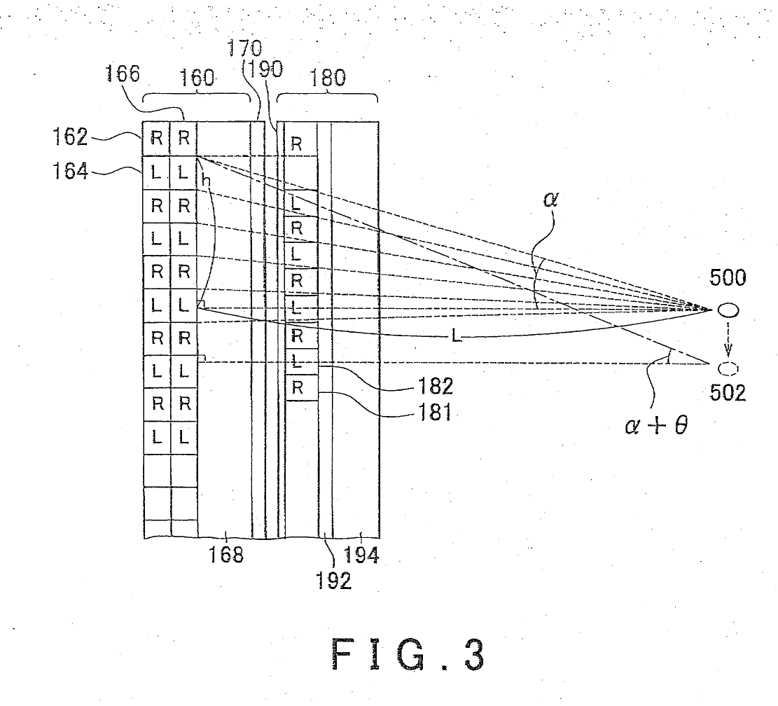

The size and the position for each of the right eye polarizing region and the left eye polarizing region will be described in detail later with reference to FIG. 3.

The right eye polarizing region 181 does not rotate the polarization axis of the incident right eye image light but directly transmits therethrough. Meanwhile, the left eye polarizing region 182 rotates the polarization axis of the incident left eye image light to the direction orthogonalized to the polarization axis of the right eye image light incident on the right eye polarizing region 181. Therefore, the direction of the polarization axis of the right eye image light transmitted through the right eye polarizing region 181 and that of the polarization axis of the left eye image light transmitted through the left eye polarizing region 182 are orthogonalized to each other shown as the arrows in FIG. 1. Here, the arrows of the polarization axis control plate 180 shown in FIG. 1 indicate the polarization axes of the polarized light transmitted through the polarization axis control plate 180. A transparent glass or resin is used for each right eye polarizing region 181, and a half wave retarder having an optical axis having the angle of 45 degrees with the direction of the polarization axis of the incident left eye image light is used for each left eye polarizing region 182, for example. The direction of the optical axis of the left eye polarizing region 182 is the horizontal direction or the vertical direction in the embodiment shown in FIG. 1.

Here, the optical axis means either the phase advance axis or the phase delay axis when light is transmitted through the left eye polarizing region 182.

In addition, the stereoscopic displaying apparatus 100 may have a diffuser panel that diffuses the right eye image light and the left eye image light transmitted through the right eye polarizing region 181 and the left eye polarizing region 182 in at least one direction of the horizontal direction or the vertical direction on the viewer 500 side, i.e. the right side of the polarization axis control plate 180 in FIG. 1. For such diffuser panel, a lenticular lens sheet on which plurality of convex lenses (cylindrical lenses) are extended in the horizontal direction or the vertical direction, or a lens array sheet on which a plurality of convex lenses are arranged on a plane is used, for example.

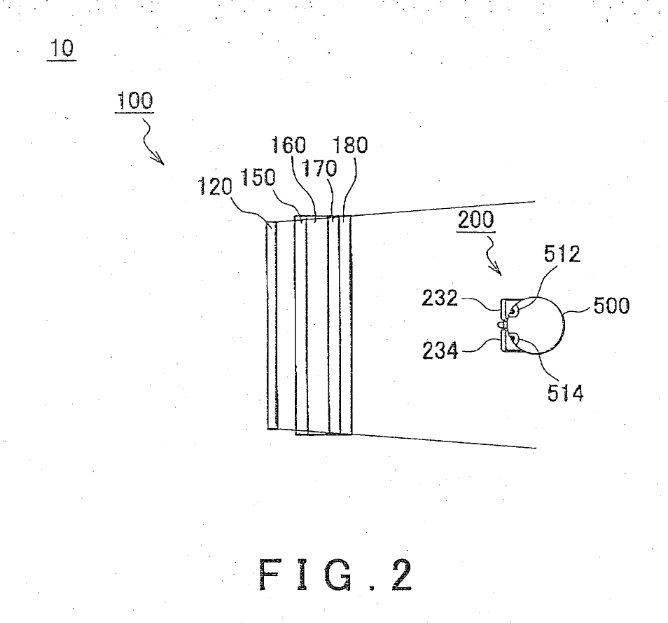

FIG. 2 is a schematic top view showing a usage state of the stereoscopic image displaying system 10. Viewing a stereoscopic image by the stereoscopic image displaying system 10, the viewer 500 views the right eye image light and the left eye image light projected from the stereoscopic displaying apparatus 100 with a polarized glasses 200 as shown in FIG. 2. When the viewer 500 wears the polarized glasses 200, a right eye image translating section 232 is disposed at the position for a right eye 512 side and a left eye image transmitting section 234 is disposed at the position for a left eye 514 side of the viewer 500.

The right eye image transmitting section 232 is a polarizing plate of which transmission axis direction is the same as that of the right eye image light transmitted through the right eye polarizing region 181 and of which absorption direction axis is orthogonalized to the transmission axis direction. Meanwhile, the left eye image transmitting section 234 is a polarizing plate of which transmission axis direction is the same as that of the left eye image light transmitted through the left eye polarizing region 182 and of which absorption direction axis is orthogonalized to the transmission axis direction. For each of the right eye image transmitting section 232 and the left eye image transmitting section 234, a polarizing lens to which a polarizing film obtained by uniaxially drawing a film impregnating dichromatic dye is attached is used, for example.

Viewing a stereoscopic image by the stereoscopic image displaying system 10, the viewer 500 views the stereoscopic displaying apparatus 100 with the polarized glasses 200 as described above within a range in which the right eye image light and the left eye image light transmitted through the right eye polarizing region 181 and the left eye polarizing region 182, respectively in the polarization axis control plate 180 are emitted so that the right eye 512 can view only the right eye image light and the left eye 514 can view only the left eye image light. Therefore, the viewer 500 can perceive the right eye image light and left eye image light as a stereoscopic image.

FIG. 3 is a side view explaining in detail the image generating section 160, the polarizing plate 170 and the polarization axis control panel 180. Here, the thickness of each component is exaggerated for explanation. In addition, lower half is omitted for ease of explanation.

As shown in FIG. 3, the image generating section 160 includes the right eye image generating regions 162, the left eye image generating regions 164, color filter 166 arranged corresponding to the right eye image generating regions 162 and the left eye image generating regions 164 that transmits therethrough light having a particular wavelength, and a glass substrate 168 that supports the right eye image generating regions 162, the left eye image generating regions 164 and the color filter 166. The polarizing plate 170 is supported by the glass substrate 168 on the viewer side opposite to the side on which the color filter is provided. Here, it is preferred that the surface of the polarizing plate 170 facing the polarization axis control plate 180 is smooth.

Moreover, the polarization axis control plate 180 has the light blocking sections 190, the right eye polarizing regions 181 and the left eye polarizing regions 182, an orientation section 192 and a glass substrate 194 from the side facing the polarizing plate 170 toward the viewer 500 side. Here, the right eye polarizing regions 181 and the left eye polarizing regions 182 may be liquid crystal, for example. The right eye polarizing regions 181 and the left eye polarizing regions 182 are oriented in accordance with the orienting direction of the orientation section 192 to have a function as the half wavelength retarder.

The right eye polarizing regions 181 and the left eye polarizing regions 182 are arranged so as not to occur any cross talk when the viewer 500 views the right eye image light and the left eye image light emitted from the right eye image generating region 162 and the left eye image generating region 164 of the image generating section 160 at a specified position. The specified position may be the center of the vertical direction of the stereoscopic displaying apparatus 100, i.e. the position is separated from the stereoscopic displaying apparatus 100 by a predetermined viewing distance, for example. Therefore, as the positions of the right eye polarizing region 181 and the left eye polarizing region 182 are upper and/or lower in Hie vertical direction, that is, as the elevation angle α with the viewing position is larger, the right eye polarizing region 181 and the left eye polarizing region 182 are displaced with each of the corresponding right eye image generating region 162 and the left eye image generating region 164 in the vertical direction as show in FIG. 3. Here, the elevation angle α is expressed by tan⁻¹(h/L), where, L is a viewing distance and h is the distance from the center of the stereoscopic displaying apparatus 100 to the interest right eye image generating region 162 and the left eye image generating region 164.

For example, the viewer 502 whose position has the elevation angle (θ+α) with the position of the viewer 500 may view the stereoscopic displaying apparatus 100 as shown in the dotted line of FIG. 3. In this case, a cross talk occurs such that a part of the left eye image light from the left eye image generating region 164 is transmitted to the viewer 502 through the right eye polarizing region 181 of the polarization axis control panel 180 as shown in the alternate long and short dash line of FIG. 3. Thus, the polarization axis control plate 180 has light blocking sections 190 arranged on the surface facing the polarizing plate 170 that block the right eye image light and the left eye image tight in the present embodiment.

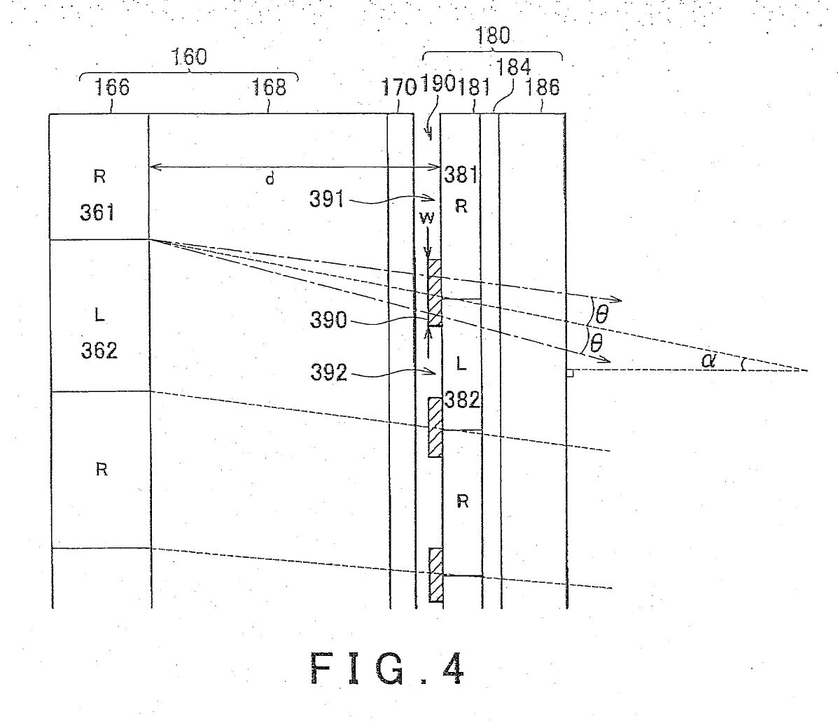

FIG. 4 is a partially enlarged view of FIG. 3 to explain light blocking sections 190. As shown in FIG. 4, a plurality of light blocking sections 190 extending in the horizontal direction are arranged on the surface of the polarization axis control plate 180 which faces the polarizing plate 170. A right eye image generating region 361 and a left eye image generating region 362 are any adjacent one set of the right eye image generating regions 162 and the left eye image generating regions 164 for purposes of illustration in FIG. 4. In the same way, a right eye polarizing region 381 and a left eye polarizing region 382 are any one set of the right eye polarizing regions 181 and the left eye polarizing regions 182 corresponding to the right eye image generating region 361 and the left eye image generating region 362. In the same way, a tight blocking section 390 is the boundary between the right eye image generating region 361 and the left eye image generating region 362 among the plurality of light blocking sections 190.

As shown in FIG. 4, the light blocking section 390 having the width w in the vertical direction is provided between the right eye polarizing region 381 and the left eye polarizing region 382. An aperture 391 and an aperture 392 through which the image light of the right eye polarizing region 381 and the image light of the left eye polarizing region 382 are transmitted respectively are arranged on both sides of the light blocking section 390. Here, the width w of the light blocking section 390 is set so as to block the image light going from the boundary between the left eye image generating region 361 and the right eye image generating region 362 toward the inside of the angle of field (±θ) with respect to the elevation angle α of the viewer 500. Therefore, it is preferred that the width w of the light blocking section 390 satisfies geometrically the following expression (1), where d is the distance between the color filter 166 and the right eye polarizing region 181.

w=d*(tan(α+θ)−tan(α−θ)) (1)

Here, since diffraction phenomenon may occur in the image light, the width w of the light blocking section 390 may be larger than the expression (1), or smaller than that in order to increase the numerical aperture.

Thereby the image light emitted from the right eye image generating region 362 and incident on the aperture 392 goes to the inside of the angle of field (±θ) while the image light emitted, from the left eye image generating region 361 adjacent to the right eye image generating region 362 and incident on the aperture 392 goes to the outside of the angle of field. Therefore, when the viewer views the stereoscopic displaying apparatus 100 from the inside of the angle of field(±θ), it is difficult to occur cross talk due to that the right eye image is incident on the left eye polarizing region and viewed by the left eye, and vice versa.

Each of the light blocking sections 190 is formed by screen printing. Here, it is preferred that the light blocking section 190 is formed of material obtained by dispersing filer components in a binder resin, for example. The filer components may be metal particles and the oxide thereof, or pigment and dye. It is preferred that the color tone of the filer components is black for the right eye image light and the left eye image light emitted from the image generating section 160. The binder resin in which the pigment and the dye are dispersed or dissolved may be a well-known resin such as acrylic resin, urethane resin, polyester, novolac resin, polyimide, epoxide resin, chloroethylene/vinyl acetate copolymer, nitrocellulose or these combination.

Here, a light blocking section may be provided on the color filter 166 at the position corresponding to each boundary between the right eye image generating regions 162 and the left eye image generating regions 164. In this case, it is preferred that the image generating section 160 the polarizing plate 170 and the polarization axis control plate 180 have each value indicated by the following Table 1.

TABLE 1

| IMAGE GENERATING SECTION 160 | | | | | | |
|---|---|---|---|---|---|---|
| | WIDTH OF | | | | | |
| | LIGHT | | | | POLARIZATION AXIS | |
| | BLOCKING | | THICKNESS | | CONTROL PANEL 180 | |
| | SECTION OF | | OF | | | WITCH OF |
| PIXEL | COLOR | THICKNESS | POLARIZING | VIEWING | | POLARIZING |
| PITCH | FILTER | OF GLASS | PLATE | DISTANCE | PIXEL PITCH | SECTION |
| (mm) | (mm) | (mm) | (mm) | (mm) | (mm) | (mm) |
| 0.15~0.8 | 0.01~0.2 | 0.3~1.1 | 0.1~0.3 | 300~7000 | DETERMINE | 0.05~0.5 |
| | | | | | BASED ON | |
| | | | | | EACH LEFT | |
| | | | | | VALUE | |

### Embodiment 1

In the embodiment 1, the cross talk rate C(θ) defined by the following expressions (2)-(4) is measured by using the stereoscopic displaying apparatus 100 in which the image generating section 160, the polarizing plate 170 and the polarization axis control plate 180 have each value indicated by the following Table 2. In the same way, the cross talk rate C(θ) is measured by using the stereoscopic displaying apparatus 100 having the condition the same as that of the embodiment 1 except that the polarization axis control plate 180 does not have any light blocking section 190 as a comparative example 1.

TABLE 2

| IMAGE GENERATING SECTION 100 | | | | | | |
|---|---|---|---|---|---|---|
| | WIDTH OF | | | | | |
| | LIGHT | | | | POLARIZATION AXIS | |
| | BLOCKING | | THICKNESS | | CONTROL PANEL 180 | |
| | SECTION OF | | OF | | | WITCH OF |
| PIXEL | COLOR | THICKNESS | POLARIZING | VIEWING | | POLARIZING |
| PITCH | FILTER | OF GLASS | PLATE | DISTANCE | PIXEL PITCH | SECTION |
| (mm) | (mm) | (mm) | (mm) | (mm) | (mm) | (mm) |
| 0.51 | 0.03 | 0.7 | 0.2 | 1500 | 0.51 | 0.22 |

C(θ)=(C_{L}(θ)+C_{R}(θ))/2 (2)

C_{L}(θ)=(R_{wL}−B_{L})/(L_{Wl}−B_{L})×100% (3)

C_{R}(θ)=(L_{wR}−B_{R})/(R_{wR}−B_{R})×100% (4)

Here, B_{L} is the luminance when the left eye image light is viewed with the angle of field θ through the left eye image transmitting section 234 in a case that the right eye image light and the left eye image light are black. L_{wL} is the luminance when the right eye image light and left eye image light are viewed with the angle of field θ through the left eye image transmitting section 234 in a case that the right eye image light is black and the left eye image light is white. R_{wL} the luminance when the right eye image light and left eye image light are viewed with the angle of field θ through the left eye image transmitting section 234 in a case that the right eye image light is white and the left eye image light is black. In the same way, B_{R} is the luminance when the right eye image light and left eye image light are viewed with the angle of field θ through the right eye image transmitting section 232 in a case that the right eye image light and the left eye image light are black. L_{wR} is the luminance when the right eye image light and left eye image light are viewed with the angle of field θ through the right eye image transmitting section 232 in a case that the right eye image light is black and the left eye image light is white. R_{wL} is the luminance when the right eye image light and left eye image light are viewed with the angle of field θ through the right eye image transmitting section 232 in a case that the right eye image light is white and the left eye image light is black.

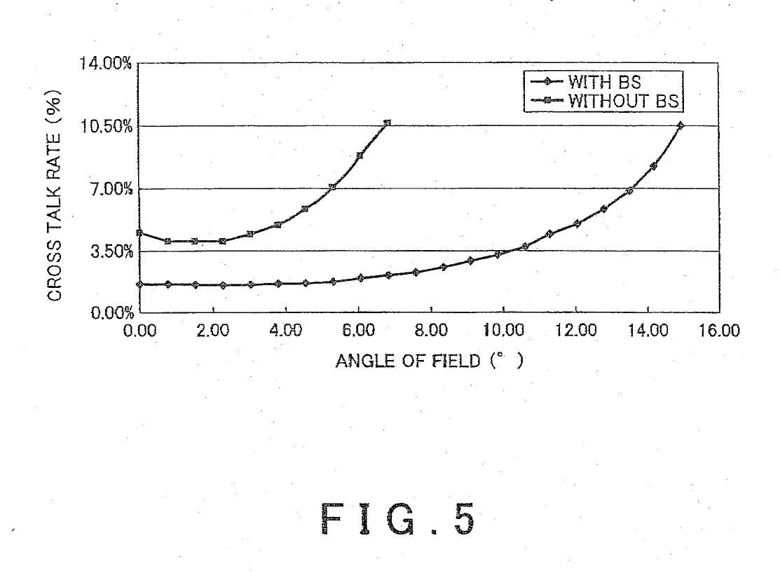

FIG. 5 shows a measuring result of cross talk rate C(θ).

As shown in FIG. 5, the larger the angle of field θ is increased, the higher the cross talk rate C(θ) is increased in the embodiment 1 and the comparative example 1. Here, for the same angle of field θ, the cross talk rate C(θ) of the embodiment 1 is less than that of the comparative example 1. In addition, the best cross talk rate of the embodiment 1 is 1.5%, meanwhile the best cross talk rate of the comparative example 1 is 4%. Moreover, the cross talk rate C(θ) is equal to or less than 7% within ±13.5 degrees of the angle of view θ. Thereby it understands that the cross talk is reduced due to the light blocking sections 190.

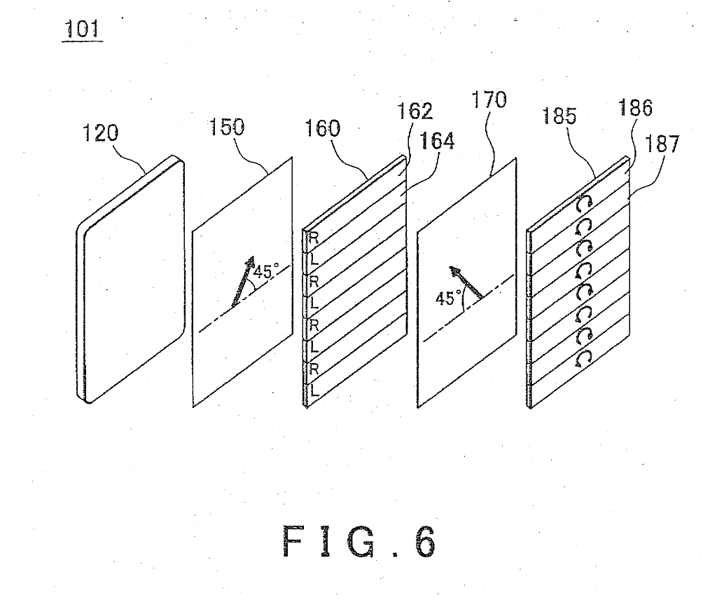

FIG. 6 is an exploded perspective view showing a stereoscopic displaying apparatus 101. The components of the image displaying apparatus 101 shown in FIG. 6 the same as those of the stereoscopic displaying apparatus 100 shown in FIG. 1 have the reference numerals the same as those of the components of the stereoscopic displaying apparatus 100, so that the description is omitted. As shown in FIG. 6, the image displaying apparatus 101 includes a polarization axis control plate 185 instead of the polarization axis control plate 180 of the stereoscopic displaying apparatus 100. The polarization axis control plate 185 includes right eye polarizing regions 186 and the left eye polarizing regions 187. Here, each of the right eye polarizing regions and the left eye polarizing regions is a quarter wave retarder, and the optical axis of each of them is orthogonalized to each other. The position and the size for each of the right eye polarizing region 186 and the left eye polarizing region 187 in the polarization axis control plate 185 are as described with reference to FIG. 3 as well as each of the right eye polarizing region 181 and the left eye polarizing region 182 in the polarization axis control plate 180. Therefore, in using the stereoscopic displaying apparatus 101, the right eye image light transmitted through the right eye image generating region 162 is incident on the right eye polarizing region 186, and the left eye image light transmitted through the left eye image generating region 164 is incident on the left eye polarizing region 187.

The polarization axis control plate 185 shown in FIG. 6 emits the incident lights as circularly polarized lights of which polarization axes are rotated in the directions opposite to each other. For example, the right eye polarizing region 186 emits the incident light as the clockwise circularly polarized light, and the left eye polarizing region 187 emits the incident light as the counterclockwise circularly polarized light. Here, the arrows of the polarization axis control plate 185 shown in FIG. 6 indicate Are rotating direction of each polarized light transmitted through the polarization axis control plate 185. For the right eye polarizing region 186, a quarter wave retarder of which optical axis is in the horizontal direction is used, and for the left eye polarizing region 187, a quarter wave retarder of which optical axis is in the vertical direction is used, for example.

Viewing the stereoscopic displaying apparatus 101 having the polarization axis control plate 185 shown in FIG. 6, quarter wave retarders each of which optical axis is orthogonalized to each other are provided 1o the viewer 500 instead of the right eye image transmitting section 232 and the left eye image transmitting section 234 of the polarized glasses 200 shown in FIG. 2. For example, the quarter wave retarder which is made of polycarbonate and of which optical axis is in the horizontal direction is used for the right eye phase shift plate.

Meanwhile, the quarter wave retarder which is made of polycarbonate and of which optical axis is in the vertical direction is used for the left eye phase shift plate. In addition, the polarized glasses has polarizing plates each of which transmission axis direction is upper right at 45 degrees from the viewpoint of the viewer 500 and each of which absorption axis direction is orthogonalized to the transmission axis at the viewer side than the phase shift plate.

Viewing the stereoscopic displaying apparatus 101 with, the polarized glasses, the viewer 500 can view only the right eye image light by the right eye 512 and only the left eye image light by the left eye 514.

Also the stereoscopic displaying apparatus 101 shown in FIG. 6 has the light blocking sections 190 shown in FIG. 4, so that the right eye image light is prevented from being incident on the left eye polarizing region to reduce cross talk.

While the present invention has been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

As evidenced by the above description, according to the present embodiment, the stereoscopic displaying apparatus that reduces cross talk of me right eye image and the left eye image within the angle of field can be provided by the light blocking sections and the apertures arranged on the polarization axis control plate.

What is claimed is:

1. A stereoscopic displaying apparatus, comprising:
an image generating section having a right eye image generating region on which a right eye image light is generated and a left eye image generating region on which a left eye image light is generated;
a polarizing plate that emits the right eye image light and the left eye image light generated by the image generating section in the same polarizing direction; and
a polarization axis control plate on which the right eye image light and the left eye image light from the polarizing plate are incident, and from which the right eye image light and the left eye image light are emitted as linear polarized rights of which polarization axes are orthogonalized to each other or circularly polarized lights of which polarization axes are rotated in the directions opposite to each other,
the polarization axis control plate including:
a right eye polarizing region on which a right eye image light is incident;
a left eye polarizing region which is arranged adjacent to the right eye polarizing region and on which a left eye image light is incident;
a plurality of light blocking sections arranged on a plane facing the polarizing plate, each of which is a boundary between the right eye polarizing region and the left eye polarizing region that blocks the right eye image light and the left eye image light; and
a plurality of apertures formed between each of the plurality of light blocking sections that transmit therethrough the right eye image light and the left eye image light,
wherein the image light emitted from one of the right eye polarizing region and the left eye polarizing region and incident on one of the plurality of apertures goes to the inside of the angle of field while the image light emitted from the other of the right eye polarizing region and the left eye polarizing region adjacent to each other and incident on the one aperture goes to the outside of the angle of field.

2. The stereoscopic displaying apparatus as set forth in claim 1, wherein the surface facing the polarization axis control plate of the polarizing plate is smooth.

3. The stereoscopic displaying apparatus as set forth in claim 1, wherein a cross talk rate C(θ) is equal to or less than 7%, which is defined by the following expressions (5)-(7) when the angle of field θ is within ±13.5 degrees,
C(θ)=(C_{L}(θ)+C_{R}(θ))/2 (5)
C_{L}(θ)=(R_{wL}−B_{L})/(L_{wL}−B_{L})×100% (6)
C_{R}(θ)=(L_{wR}−B_{R})/(R_{wR}−B_{R})×100% (7)
where, B_{L} is the luminance when the left eye image light is viewed with the angle of field θ through the left eye image transmitting section in a case that the right eye image light and the left eye image light are black, L_{wL} is the luminance when the right eye image light and left eye image light are viewed with the angle of field θ through the left eye image transmitting section through which the image light emitted from the left eye polarizing region is transmitted in a case that the right eye image light is black and the left eye image light is white, R_{wL} is the luminance when the right eye image light and left eye image light are viewed with the angle of field θ through the left eye image transmitting section in a case that the right eye image light is white and the left eye image light is black, B_{R} is the luminance when the right eye image light and left eye image light are viewed with the angle of field θ through the right eye image transmitting section through which the image light emitted from the right eye polarizing region is transmitted in a case that the right eye image light and the left eye image light are black L_{wR} is the luminance when the right eye image light and left eye image light are viewed with the angle of field θ through the right eye image transmitting section in a case that the right eye image light is black and the left eye image light is white, R_{wL} is the luminance when the right eye image light and left eye image light are viewed with the angle of field θ through the right eye image transmitting section in a case that the right eye image light is white and the left eye image light is black.
